(19) United States
(12) Patent Application Publication
(10) Pub. No.: US 2024/0128017 A1
(43) Pub. Date: Apr. 18, 2024

(54) COIL DEVICE

(71) Applicant: TDK XIAMEN CO., LTD., Xiamen (CN)

(72) Inventors: Hiroshi MAEDA, Xiamen (CN); XiaoBo ZHOU, Xiamen (CN); ZhenSheng LIU, Xiamen (CN); XueSong GUO, Xiamen (CN)

(73) Assignee: TDK XIAMEN CO., LTD., Xiamen (CN)

(21) Appl. No.: 18/484,691

(22) Filed: Oct. 11, 2023

(30) Foreign Application Priority Data
Oct. 13, 2022 (CN) 202211252890.6

(51) Int. Cl. H01F 27/32

(52) U.S. Cl. CPC H01F 27/325

(57) ABSTRACT

A coil device includes a first coil a first coil formed by a first wire wound in a coil shape and a second coil formed by a second wire wound in a coil shape. The first coil includes a first portion provided inside the second coil and a second portion next to the first portion and the second coil along a winding axis of the first portion. A layer number of the first portion in its radial direction is one. A layer number of the second portion in its radial direction is plural.

### BACKGROUND OF THE INVENTION

The present disclosure relates to a coil device used as a leakage transformer or so.

As a coil device used as a leakage transformer, for example, the following two types of coil devices are known. As a first type of coil device, there is a high-coupling type coil device in which a second coil is disposed on a first coil (Patent Document 1). As a second type of coil device, there is a split-type coil device in which a first coil and a second coil are next to each other along a winding axis (Patent Document 2).

The first type of coil device is characterized by low leakage magnetic flux. Thus, for the purpose of adjusting the leakage magnetic flux to an appropriate value (increase the leakage magnetic flux), for example, it is necessary to separate the first coil and the second coil in the radial direction or to attach another coil device externally. In this case, however, the coil device may become larger as the radial distance between the first coil and the second coil increases. Moreover, the coil device may become complicated as the coil device is attached externally.

Meanwhile, the second type of coil device is characterized by large leakage magnetic flux. Thus, for the purpose of adjusting the leakage magnetic flux to an appropriate value (reduce the leakage magnetic flux), for example, it is necessary to increase the layer number of each of the first coil and the second coil in its radial direction. In this case, however, the coil device may become larger as the layer number of each of the first coil and the second coil in its radial direction increases.
Patent Document 1: JP2006310648 (A)
Patent Document 2: JP2014236128 (A)

### BRIEF SUMMARY OF THE INVENTION

The present disclosure has been achieved under such circumstances. It is an object of the disclosure to provide a coil device capable of adjusting the leakage magnetic flux to an appropriate value without enlargement or complication of the coil device.

To achieve the above object, a coil device according to a first aspect of the present disclosure comprises:
a first coil formed by a first wire wound in a coil shape; and
a second coil formed by a second wire wound in a coil shape,
wherein
the first coil includes:
   a first portion provided inside the second coil; and
   a second portion next to the first portion and the second coil along a winding axis of the first portion,
a layer number of the first portion in its radial direction is one, and
a layer number of the second portion in its radial direction is plural.

In the coil device according to the first aspect, the first coil includes a first portion (single-layer portion) provided inside the second coil and a second portion (multiple-layer portion) next to the first portion and the second coil along a winding axis of the first portion. Since the second coil is provided outside the first portion of the first coil, the effect of reducing leakage magnetic flux is exhibited by the same effect as in the conventional first type coil device. Also, since the second coil is next to the second portion of the first coil along the winding axis of the first portion, the effect of increasing leakage magnetic flux is exhibited by the same effect as in the conventional second type coil device. Thus, the coil device according to the first aspect has a portion for contributing to reduction in leakage magnetic flux and a portion for contributing to increase in leakage magnetic flux. Then, by organically combining these portions, the leakage magnetic flux can be adjusted to an appropriate value without enlargement or complication of the coil device, which cannot be avoided with the conventional first type or second type coil device alone.

In particular, since the layer number of the first portion in its radial direction is one, the winding number of the first portion can be reduced, and it is thus possible to prevent variations in the winding shape and winding position of the first portion. As a result, it is also possible to prevent variations in winding shape and winding position for the second coil disposed on the first portion. This makes it possible to prevent variations in the leakage magnetic flux and to adjust the leakage magnetic flux to an appropriate value.

The first portion may include mutually continuous first turn portions, and the first turn portions next to each other may be separated from each other along the winding axis. In this case, the leakage magnetic flux can be adjusted to an appropriate value by adjusting the distance between the first turn portions next to each other.

The second portion may include mutually continuous second turn portions, and one of the second turn portions may be disposed on the first turn portions next to each other while crossing over the first turn portions. In this case, the second turn portions can be fixed in recesses (or gaps) between the first turn portions next to each other, and the positional displacement of the second turn portions can be prevented. Thus, the positional relations between the first turn portions and the second turn portions are optimized, and the leakage magnetic flux can be adjusted to an appropriate value.

The first portion and a first layer of the second portion may be continuous to each other. In this case, it is possible to prevent variations in the winding shape and winding position of the first coil between the first portion and the first layer of the second portion.

The coil device according to the first aspect may further comprise a bobbin for disposing the first coil, the bobbin may include a first region for disposing the first portion, and protrusion portions protruding in a radial direction of the bobbin may be arranged along an axial direction of the bobbin on an outer peripheral surface of the first region. In this case, the first portion can be formed in the first region while fixing the first wire to the protrusion portions. Thus, it is possible to prevent variations in the winding shape and winding position of the first portion. Also, in the first portion, the distance between the first turn portions next to each other can be adjusted by the protrusion portions. This makes it possible to adjust the leakage magnetic flux to an appropriate value.

The protrusion portions may extend along a circumferential direction of the bobbin, one of the protrusion portions may be provided with a notch, and the first wire passes through the notch. In this case, for example, when the first portion is formed in the first region, the first wire can be wound from one side to the other side via the notch along the axial direction of the bobbin without being hindered by the protrusion portions.

The first portion may include mutually continuous first turn portions, and one of the first turn portions may be disposed between the protrusion portions next to each other. In this case, a single first turn portion is interposed between the protrusion portions next to each other, and it is thus possible to fix the winding position of each of the first turn portions. This makes it possible to prevent variations in the winding shape and winding position of the first portion and makes it easy to adjust the leakage magnetic flux.

The first portion may include mutually continuous first turn portions, the second coil may include mutually continuous second turn portions, one of the first turn portions may be next to one of the protrusion portions along the winding axis, and one of the second turn portions may be mounted on one of the first turn portions and one of the protrusion portions next to each other while crossing over the one of the first turn portions and the one of the protrusion portions. In this case, the second turn portions can be fixed in recesses (or gaps) between the first turn portions and the protrusion portions, and the positional displacement of the second turn portions can be prevented. Thus, the positional relations between the first turn portions and the second turn portions are optimized, and the leakage magnetic flux can be adjusted to an appropriate value.

A protrusion length of the protrusion portions may be equal to a diameter of the first wire. In this case, when the first turn portions are arranged next to the protrusion portions, the steps between the first turn portions and the protrusion portions can be reduced. Thus, when the second turn portions are mounted on the first turn portions and the protrusion portions, the positional displacement of the second turn portions can be prevented.

One of the protrusion portions may include a wide portion and a narrow portion, and a width of the wide portion may be larger than a width of the narrow portion in the axial direction of the bobbin. For example, the winding shape and winding position of the first coil can be adjusted (e.g., the first wire is put to one side of the bobbin in its axial direction) at the position of the wide portion by winding the first wire around the first region so that the first wire passes next to the wide portion. This makes it possible to adjust the leakage magnetic flux to an appropriate value.

The protrusion portions may include a first protrusion portion and a second protrusion portion having a width along the axial direction of the bobbin different from that of the first protrusion, and the first protrusion portion and the second protrusion portion may be arranged along the axial direction of the bobbin. In this case, the distance between the first turn portions next to each other can be adjusted at the position of the second protrusion portion. For example, when the width of the second protrusion portion is larger than the width of the first protrusion portion, the distance between the first turn portions next to each other can be increased at the position of the second protrusion portion. This makes it possible to adjust the winding shape and winding position of the first coil and to adjust the leakage magnetic flux to an appropriate value.

The bobbin may include: a second region for disposing the second portion; and a partition protrusion portion protruding in the radial direction of the bobbin, the partition protrusion portion may be formed on the outer peripheral surface of the bobbin between the first region and the second region and provided with a notch, and the first wire may pass through the notch. In this case, for example, the first wire can continuously be wound around the bobbin via the notch from the first portion to the first layer of the second portion.

The bobbin may include a first bobbin for disposing the first coil and a second bobbin for disposing the second coil, the first bobbin may include the first region, the second bobbin may include a third region for disposing the second coil, and the third region may be provided outside the first region. In this case, since the second coil is provided outside the first portion of the first coil, the effect of reducing leakage magnetic flux is exhibited by the same effect as in the conventional first type coil device. Also, the radial distance between the first coil and the second coil can be adjusted depending on the diameter of the second bobbin. This makes it possible to adjust the leakage magnetic flux to an appropriate value.

To achieve the above object, a coil device according to a second aspect of the present disclosure comprises:
a bobbin;
a first coil provided to the bobbin;
a second coil provided outside the first coil,
wherein
the first coil includes:
   a first portion provided inside the second coil; and
   a second portion next to the first portion and the second coil along a winding axis of the first portion,
the bobbin includes a first region for disposing the first portion, and
protrusion portions protruding in a radial direction of the bobbin are arranged on an outer peripheral surface of the first region along an axial direction of the bobbin.

In the coil device according to the second aspect, the first coil includes a first portion provided inside the second coil and a second portion next to the first portion and the second coil along a winding axis of the first portion. Thus, the first coil has a portion for contributing to reduction in leakage magnetic flux (the portion where the first portion and the second coil overlap with each other in the radial direction) and a portion for contributing to increase in leakage magnetic flux (the portion where the second portion and the second coil are next to each other in the winding axis direction). Thus, the leakage magnetic flux can be adjusted to an appropriate value without enlargement or complication of the coil device, which cannot be avoided with the conventional first type or second type coil device alone.

In particular, protrusion portions protruding in a radial direction of the bobbin are arranged discontinuously along an axial direction of the bobbin on an outer peripheral surface of the first region of the bobbin. In this case, the first portion can be formed in the first region while fixing the first wire to the protrusion portions. Thus, it is possible to prevent variations in the winding shape and winding position of the first portion. Also, in the first portion, the distance between the first turn portions next to each other can be adjusted by the protrusion portions. This makes it possible to adjust the leakage magnetic flux to an appropriate value.

### BRIEF DESCRIPTION OF THE DRAWING(S)

FIG. 1 is a perspective view of a coil device according to First Embodiment;

FIG. 2 is an exploded perspective view of the coil device shown in FIG. 1;

FIG. 3 is a perspective view of a bobbin shown in FIG. 2;

FIG. 4 is a cross-sectional view of the coil device shown in FIG. 1 taken along the line IV-IV;

FIG. 5A is a side view of a first wire wound around the bobbin shown in FIG. 3;

FIG. 5B is a perspective view of a modified example of the bobbin shown in FIG. 5A;

FIG. 6 is a cross-sectional view of the coil device shown in FIG. 1 taken along the line VI-VI;

FIG. 7 is a perspective view of a coil device according to Second Embodiment;

FIG. 8 is an exploded perspective view of a first bobbin and a second bobbin of the coil device shown in FIG. 7;

FIG. 9 is a side view in which a first coil and a second coil are wound around the first bobbin and the second bobbin, respectively, shown in FIG. 8;

FIG. 10 is a cross-sectional view of the coil device shown in FIG. 7 taken along the line X-X;

FIG. 11 is a perspective view of a coil device according to Third Embodiment;

FIG. 12 is a perspective view of a bobbin shown in FIG. 11;

FIG. 13A is a side view of a first wire wound around the bobbin shown in FIG. 12;

FIG. 13B is a side view of a first wire wound around a modified example of the bobbin shown in FIG. 13A; and

FIG. 14 is a cross-sectional view of the coil device shown in FIG. 11 taken along the line XIV-XIV.

### DETAILED DESCRIPTION OF THE INVENTION

Hereinafter, embodiments of the present disclosure are described with reference to the figures. Although the embodiments are described with reference to the figures as necessary, the illustrated contents are only schematically and exemplarily shown for understanding of the present disclosure, and the appearance, dimensional ratio, etc. may be different from the actual one. Hereinafter, the present disclosure is specifically described based on the embodiments, but the present disclosure is not limited to the embodiments.

### First Embodiment

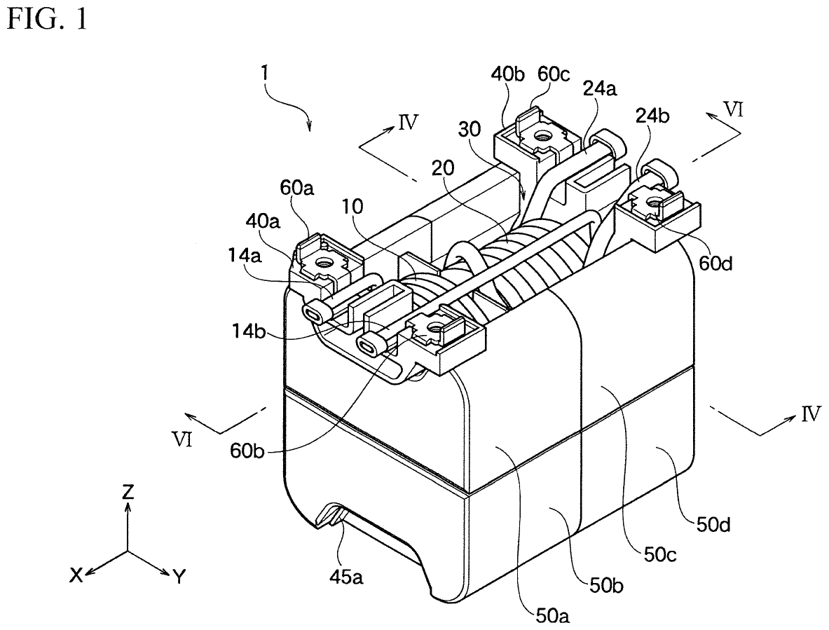

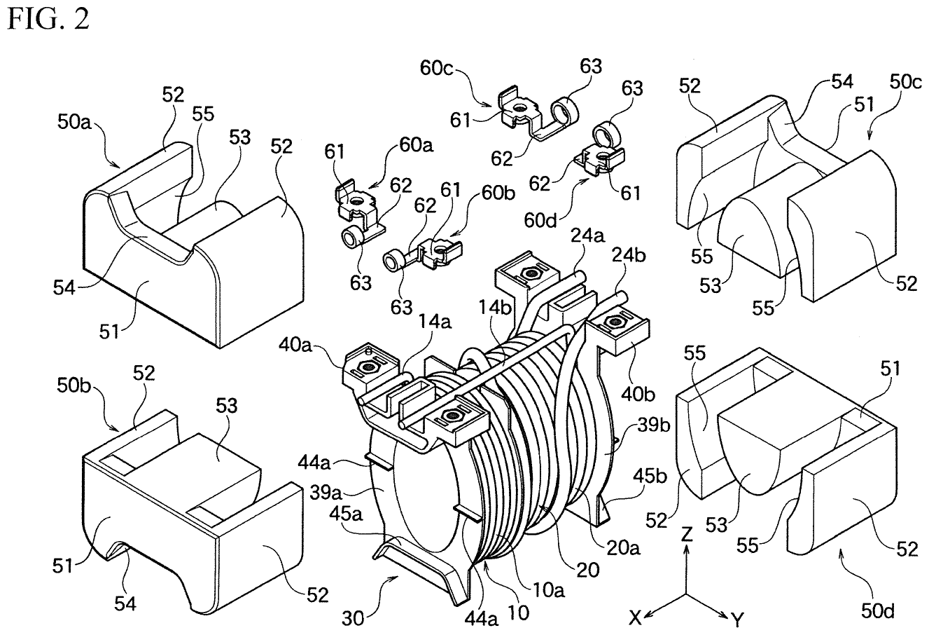

A coil device 1 shown in FIG. 1 functions as, for example, a leakage transformer and is mounted in power supply circuits of various electric devices. As shown in FIG. 2, the coil device 1 includes a first coil 10 formed by winding a first wire 10a, a second coil 20 formed by winding a second wire 20a, and a bobbin 30. In addition to the first coil 10, the second coil 20, and the bobbin 30, the coil device 1 may include cores 50a to 50d and terminals 60a to 60d. In the present embodiment, the first coil 10 and the second coil 20 are provided to the bobbin 30. However, the first coil 10 and the second coil 20 may be provided to the cores 50a to 50d without the bobbin 30.

In the figures, the X-axis is an axis corresponding to the longitudinal direction (axial direction) of the bobbin 30, the Y-axis is an axis corresponding to the lateral direction of the bobbin 30 (the direction in which the terminals 60a and 60b face each other), and the Z-axis is an axis perpendicular to the X-axis and the Y-axis. Hereinafter, for each of the X-axis, Y-axis, and Z-axis, the direction toward the center of the coil device 1 is defined as “inside”, and the direction away from the center of the coil device 1 is defined as “outside”. Also, the positive side of the Z-axis is defined as “upper”, and the negative side of the Z-axis is defined as “lower”.

The coil device 1 is a horizontal-type coil device in which the core axis of the bobbin 30 is disposed in parallel to a mounting board (not shown). In the present embodiment, “parallel” is not limited to being strictly parallel, and an error within, for example, ±10 degrees is allowed. Also, “perpendicular” is not limited to being strictly perpendicular, and an error within, for example, ±10 degrees is allowed.

For example, the coil device 1 has a length of 20 to 60 mm along the X-axis, a length of 10 to 60 mm along the Y-axis, and a length of 10 to 70 mm along the Z-axis. However, the size of the coil device 1 is not limited to this.

The first wire 10a and the second wire 20a are composed of, for example, insulation-coated wires obtained by coating copper wires with insulation. The first wire 10a and the second wire 20a are composed of single wires, but may be composed of twisted wires. The first wire 10a or the second wire 20a has a diameter of, for example, 1.0 to 3.0 mm. The diameter of the second wire 20a is larger than the diameter of the first wire 10a, but may be equivalent to or smaller than the diameter of the first wire 10a. Note that, in the present embodiment, “equivalent”, “equal”, “same”, or “similar” is not limited to being strictly equal and allows an error within, for example, ±10%.

The cores 50a to 50d are E-shaped cores and have the same shape. However, any of the cores 50a to 50d may have a different shape. Materials for the cores 50a to 50d are not limited and include magnetic materials, such as metal and ferrite. The cores 50a and 50b may be integrated, and the cores 50c and 50d may be integrated.

The cores 50a to 50d are attached to the bobbin 30. The core 50a includes a base portion 51, outer leg portions 52 formed at both ends of the base portion 51 in the Y-axis direction, and a middle leg portion 53 formed between one outer leg portion 52 and the other outer leg portion 52. The configurations of the cores 50b to 50d are similar to the configuration of the core 50a and are not thus described in detail.

The base portion 51 may be provided with a base recess portion 54. The base recess portion 54 is formed on a side surface of the base portion 51, namely, a surface perpendicular to the surface on which the middle leg portion 53 is formed. The side surfaces of the base portion 51 are recessed at the position of the base recess portion 54. At least a part of a terminal block 40a of the bobbin 30 is disposed in the base recess portion 54 of the core 50a. At least a part of the terminal block 40b of the bobbin 30 is disposed in the base recess portion 54 of the core 50c. A leg portion 45a of the bobbin 30 is disposed in the base recess portion 54 of the core 50b. A leg portion 45b of the bobbin 30 is disposed in the base recess portion 54 of the core 50d.

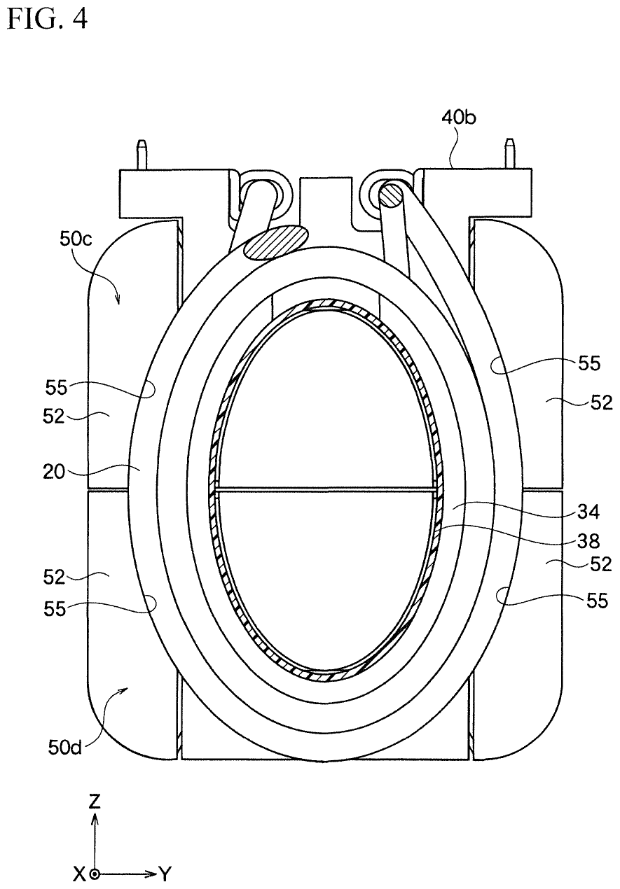

The outer leg portions 52 may be provided with outer leg recess portions 55. The outer leg recess portions 55 are formed on inner surfaces of the outer leg portions 52, namely, the surfaces facing the middle leg portion 53. The inner surfaces of the outer leg portions 52 are recessed at the positions of the outer leg recess portions 55. In the cores 50a and 50b, the inner surfaces of the outer leg portions 52 may be curved along the outer peripheral surface of the first coil 10. In the cores 50c and 50d, the inner surfaces of the outer leg portions 52 may be curved along the outer peripheral surface of the second coil 20 (FIG. 4).

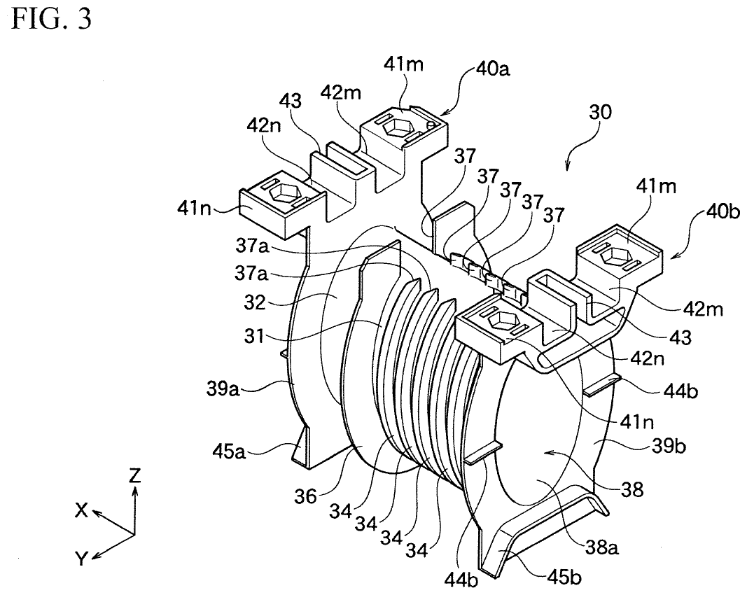

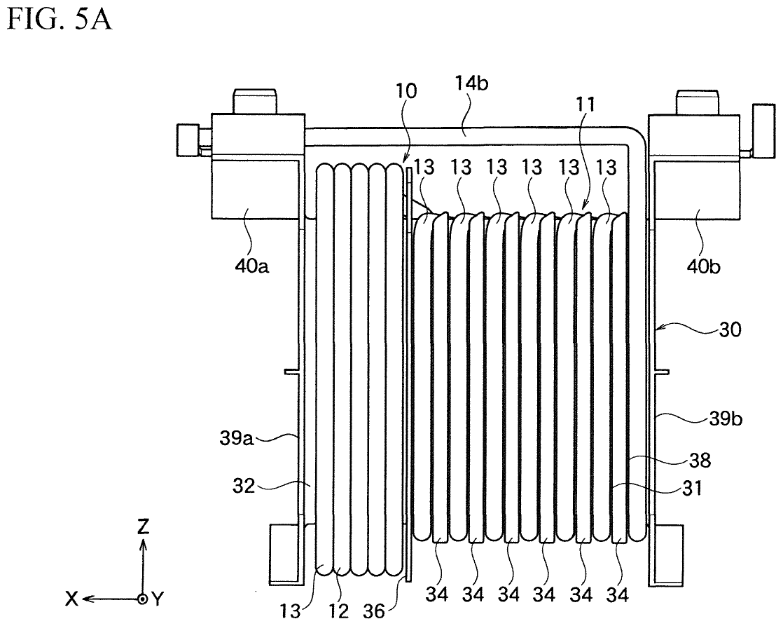

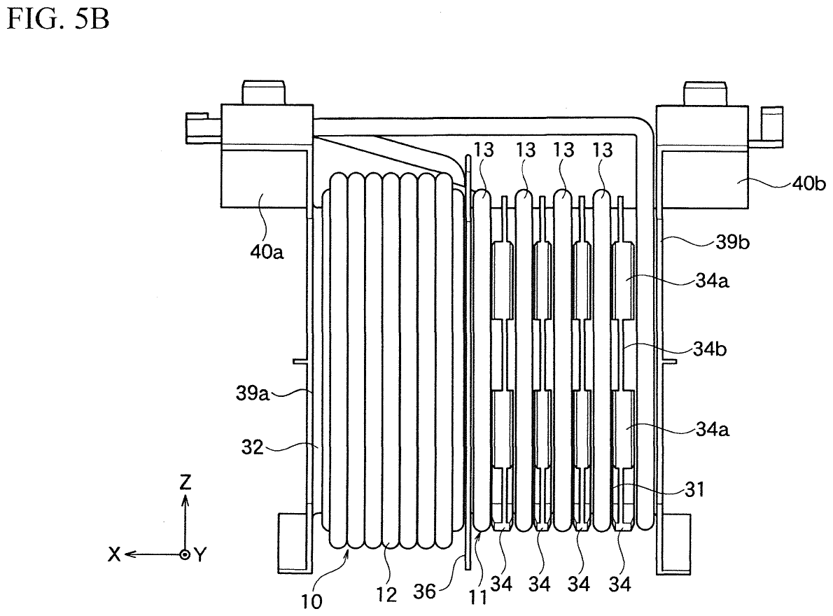

As shown in FIG. 3, the bobbin 30 is composed of an insulating material, such as resin. The bobbin 30 includes a tube portion 38. The tube portion 38 includes a through hole 38a, and the middle leg portions 53 of the cores 50a to 50d (FIG. 2) are inserted into the through hole 38a. The first coil 10 is disposed (wound) on the outer peripheral surface of the tube portion 38 (FIG. 5A).

A flange portion 39a may be formed at one end of the tube portion 38 in the X-axis direction, and a flange portion 39b may be formed at the other end of the tube portion 38 in the X-axis direction. The flange portions 39a and 39b protrude along the radial direction of the tube portion 38 and extend along the circumferential direction of the tube portion 38. The flange portions 39a and 39b continuously encircle the tube portion 38 along its circumferential direction, but may intermittently encircle the tube portion 38 along its circumferential direction. The flange portion 39a and the flange portion 39b have the same shape, but may have different shapes.

The flange portion 39a may be provided with a terminal block 40a, two projections 44a (FIG. 2), and a leg portion 45b. The flange portion 39b may be provided with a terminal block 40b, two projections 44b, and a leg portion 45b. The projections 44a (FIG. 2) project outward in the X-axis from an end surface of the flange portion 39a. The projections 44a are arranged between the core 50a (FIG. 2) and the core 50b. The projections 44b project outward in the X-axis from an end surface of the flange portion 39b. The projections 44b are arranged between the core 50c (FIG. 2) and the core 50d.

The leg portion 45a is located at the lower end of the flange portion 39a. At least a part of the leg portion 45a may protrude outward in the X-axis from the end surface of the flange portion 39a. The leg portion 45b is located at the lower end of the flange portion 39b. At least a part of the leg portion 45b may protrude outward in the X axis from the end surface of the flange portion 39b. The leg portions 45a and 45b have a role of supporting the tube portion 38.

The terminal block 40a may be located at the upper end of the flange portion 39a and may protrude outward in the X-axis from the end surface of the flange portion 39a. The terminal block 40a may include terminal fixation portions 41m and 41n, recess portions 42m and 42n, and an insulation portion 43. However, the configuration of the terminal block 40a is not limited to the configuration shown in FIG. 3.

The terminal fixation portion 41m is formed at one end of the terminal block 40a in the Y-axis direction, and the terminal fixation portion 41n is formed at the other end of the terminal block 40a in the Y-axis direction. The terminals 60a and 60b (FIG. 2) are fixed to the terminal fixation portions 41m and 41n, respectively. The terminal fixation portions 41m and 41n may be provided with holes for engaging with the terminals 60a and 60b, respectively.

The insulation portion 43 is formed at a central part of the terminal block 40a in the Y-axis direction. The insulation portion 43 has a role of insulating the terminal 60a (FIG. 2) from the terminal 60b. The groove portion 42m is formed between the terminal fixation portion 41m and the insulation portion 43 and penetrates the terminal block 40a along the X-axis. A part of the terminal 60a (FIG. 2) is disposed in the groove portion 42m. The groove portion 42n is formed between the terminal fixation portion 41n and the insulation portion 43 and penetrates the terminal block 40a along the X-axis. A part of the terminal 60b (FIG. 2) is disposed in the groove portion 42n.

The terminal block 40b may be located at the upper end of the flange portion 39b and may protrude outward in the X-axis from the end surface of the flange portion 39b. The terminal block 40b may include terminal fixation portions 41m and 41n, recess portions 42m and 42n, and an insulation portion 43. However, the configuration of the terminal block 40b is not limited to the configuration shown in FIG. 3.

The terminal fixation portion 41m is formed at one end of the terminal block 40b in the Y-axis direction, and the terminal fixation portion 41n is formed at the other end of the terminal block 40b in the Y-axis direction. The terminals 60c and 60d (FIG. 2) are fixed to the terminal fixation portions 41m and 41n, respectively. The terminal fixation portions 41m and 41n may be provided with holes for engaging with the terminals 60c and 60d (FIG. 2), respectively.

The insulation portion 43 is formed at a central part of the terminal block 40b in the Y-axis direction. The insulation portion 43 has a role of insulating the terminal 60c (FIG. 2) from the terminal 60d. The groove portion 42m is formed between the terminal fixation portion 41m and the insulation portion 43 and penetrates the terminal block 40b along the X-axis. A part of the terminal 60c (FIG. 2) is disposed in the groove portion 42m. The groove portion 42n is formed between the terminal fixation portion 41n and the insulation portion 43 and penetrates the terminal block 40b along the X-axis. A part of the terminal 60d (FIG. 2) is disposed in the groove portion 42n.

The outer peripheral surface of the tube portion 38 may be provided with a partition protrusion portion 36 protruding in the radial direction of the tube portion 38 and first protrusion portions 34 protruding in the radial direction of the tube portion 38. The partition protrusion portion 36 is located between the flange portion 39a and the flange portion 39b and extends along the circumferential direction of the tube portion 38. The partition protrusion portion 36 is located on one side of the center in the axial direction of the tube portion 38, but may be located at the center in the axial direction of the tube portion 38 or on the other side of the center in the axial direction of the tube portion 38. The partition protrusion portion 36 may protrude outward from the position of the outer peripheral surface of the first coil 10 (FIG. 2) or the outer peripheral surface of the second coil 20 along the radial direction of the tube portion 38. The protrusion length of the partition protrusion portion 36 is not limited, but for example, may be twice or three times or more the diameter of the first wire 10a or may be twice or three times or more the diameter of the second wire 20a.

A notch 37 may be formed in a part of the partition protrusion portion 36 in its extending direction (circumferential direction). At the position of the notch 37, a gap is formed between one end and the other end of the partition protrusion portion 36 in its extending direction. The notch 37 is for passing the first wire 10a (FIG. 2) from one side to the other side in the X-axis direction through the partition protrusion portion 36. Note that, the number of notches 37 is one, but may be plural. Moreover, the position of the notch 37 is not limited.

The first protrusion portions 34 are arranged along the axial direction of the tube portion 38. The first protrusion portions 34 are located between the partition protrusion portion 36 and the flange portion 39b and extend along the circumferential direction of the tube portion 38. In FIG. 3, five first protrusion portions 34 are arranged along the axial direction of the tube portion 38, but the number of first protrusion portions 34 is not limited to this. The protrusion length of the first protrusion portions 34 is smaller than the protrusion length of the partition protrusion portion 36. The protrusion length of the first protrusion portions 34 is equal to the diameter of the first wire 10a (FIG. 2), but may be smaller or larger than the diameter of the first wire 10a. For example, the protrusion length of the first protrusion portions 34 is ½ times or more and 2 times or less the diameter of the first wire 10a.

The width of the first protrusion portions 34 in the X-axis direction is larger than the width of the partition protrusion portion 36 in the X-axis direction, but may be equal to or smaller than the width of the partition protrusion portion 36 in the X-axis direction. The width of the first protrusion portions 34 in the X-axis direction is equal to the diameter of the first wire 10a, but may be smaller or larger than the diameter of the first wire 10a. For example, the width of the first protrusion portions 34 in the X-axis direction is ½ times or more and 2 times or less the diameter of the first wire 10a. Note that, the width in the X-axis direction of the protrusion portion 34 next to the partition protrusion portion 36 may be larger than the widths of the other first protrusion portions 34 in the X-axis direction. Also, the width in the X-axis direction of the protrusion portion 34 next to the flange portion 39b may be larger than the widths of the other first protrusion portions 34 in the X-axis direction.

Notches 37 may be formed in a part of the first protrusion portions 34 in their extending directions (circumferential directions). At the positions of the notches 37, gaps are formed between one ends and the other ends of the first protrusion portions 34 in their extending directions. The notches 37 are for passing the first wire 10a from one side to the other side in the X-axis direction through the first protrusion portions 34.

The distance between one first protrusion portion 34 and the other first protrusion portion 34 next to each other in the X-axis direction is larger than the diameter of the first wire 10a. The distance between one first protrusion portion 34 and the other first protrusion portion 34 may be less than twice the diameter of the first wire 10a or may be smaller than the diameter of the second wire 20a.

The distance between the first protrusion portions 34 and the partition protrusion portion 36 next to each other in the X-axis direction is larger than the diameter of the first wire 10a. The distance between the first protrusion portions 34 and the partition protrusion portion 36 next to each other may be less than twice the diameter of the first wire 10a or may be smaller than the diameter of the second wire 20a.

The distance between the first protrusion portion 34 and the flange portion 39b next to each other in the X-axis direction is larger than the diameter of the first wire 10a. The distance between the first protrusion portion 34 and the flange portion 39b next to each other in the X-axis direction may be less than twice the diameter of the first wire 10a or may be smaller than the diameter of the second wire 20a. Note that, the distances of the above-described three sections (the section between one first protrusion portions 34 and the other first protrusion portions 34, the section between the first protrusion portion 34 and the partition protrusion portion 36, and the section between the first protrusion portion 34 and the flange portion 39b) may be equal to each other or may be different from each other.

The first wire 10a is wound between one first protrusion portion 34 and the other first protrusion portion 34 next to each other. Here, at the position of each of the notches 37, a tip portion 37a having a tapering shape is formed at one end and the other end of the first protrusion portion 34 in its extending direction (circumferential direction). When the tip portion 37a is formed, the wire 10a can easily enter between one first protrusion portion 34 and the other first protrusion portion 34 via the notch 37. Note that, the number of notches 37 for each of the first protrusion portions 34 is one, but may be plural. Also, the position of the notch 37 is not limited.

Hereinafter, a region of the tube portion 38 located between the partition protrusion portion 36 and the flange portion 39b along the X-axis direction is referred to as a “first region 31”. Also, a region of the tube portion 38 located between the partition protrusion portion 36 and the flange portion 39a along the X-axis direction is referred to as a “second region 32”. The partition protrusion portion 36 is located between the first region 31 and the second region 32 and partitions them. The width of the first region 31 in the X-axis direction is larger than the width of the second region 32 in the X-axis direction, but may be equal to or smaller than the width of the second region 32 in the X-axis direction.

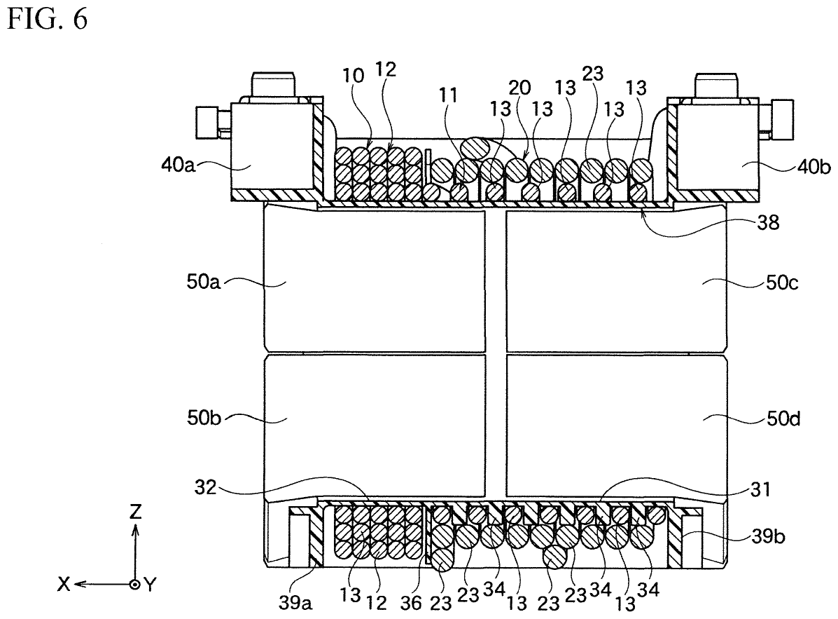

As shown in FIG. 5A, the first coil 10 includes a first portion 11 disposed (wound) in the first region 31 and a second portion 12 disposed (wound) in the second region 32. As shown in FIG. 6, the second coil 20 is disposed (wound) outside the first portion 11 in the first region 31. In other words, the first portion 11 is a portion disposed inside the second coil 20. The second portion 12 is next to the first portion 11 and the second coil 20 along the X-axis. Note that, the core axis of the tube portion 38, the winding axis of the first coil 10 (the first portion 11 and the second portion 12), and the winding axis of the second coil 20 are parallel to each other.

The layer number of the first portion 11 in its radial direction is preferably one, but may be plural. The layer number of the second portion 12 in its radial direction is three, but may be one, two, or four or more. The first portion 11 and the first layer of the second portion 12 are continuous. Thus, it is possible to prevent variations in the winding shape and winding position of the first coil 10 between the first portion 11 and the first layer of the second portion 12. The layer number of the second coil 20 in its radial direction is two, but may be one or three or more.

The first portion 11 and the second portion 12 are formed on the outer peripheral surface of the tube portion 38, but may be formed directly on the outer peripheral surfaces of the cores 50a to 50d. The second coil 20 is formed on (in contact with) the outer peripheral surface of the first portion 11, but for example, an insulating member may be disposed between the first portion 11 and the second coil 20.

The first portion 11 includes mutually continuous first turn portions 13. One of the first turn portions 13 is disposed between one first protrusion portion 34 and the other first protrusion portion 34 next to each other. One of the first turn portions 13 is disposed between the partition protrusion portion 36 and the first protrusion portion 34 next to each other. One of the first turn portions 13 is disposed between the flange portion 39b and the first protrusion portion 34 next to each other.

The first protrusion portion 34 is disposed between one first turn portion 13 and an other first turn portion 13 next to each other. Thus, one first turn portion 13 and the other first turn portion 13 are separated from each other along the X-axis. The leakage magnetic flux between the first coil 10 and the second coil 20 can be adjusted to an appropriate value by adjusting the distance between one first turn portion 13 and the other first turn portion 13 (particularly, by arranging the first turn portions 13 sparsely rather than densely) depending on the width of the first protrusion portion 34 in the X-axis direction (or regardless of the width of the first protrusion portion 34 in the X-axis direction). The distance between one first turn portion 13 and the other first turn portion 13 is equal to the width of the first protrusion portion 34 in the X-axis direction, but may be larger than the width of the first protrusion portion 34 in the X-axis direction. For example, the distance between one first turn portion 13 and the other first turn portion 13 is ½ times or more and 2 times or less the diameter of the first wire 10a.

A single first turn portion 13 is disposed between one first protrusion portion 34 and the other first protrusion portion 34 next to each other. In this case, the single first turn portion 13 is interposed between one first protrusion portion 34 and the other first protrusion portion 34. Thus, the winding position of each of the first turn portions 13 is fixed, and it is possible to prevent variations in the winding shape and winding position of the first portion 11. This makes it easy to adjust the leakage magnetic flux between the first coil 10 and the second coil 20. However, two or more first turn portions 13 may be arranged next to each other in the X-axis direction between one first protrusion portion 34 and the other first protrusion portion 34 and may be arranged next to each other in the radial direction of the tube portion 38.

The first turn portion 13 is disposed next to the first protrusion portion 34 along the X-axis. One of the first turn portions 13 may be in contact with the first protrusion portion 34 located on its one side in the X-axis direction or with the first protrusion portions 34 located on its both sides in the X-axis direction. In this case, the first portion 11 can be formed in the first region 31 while fixing the first turn portion 13 (the first wire 10a) to the first protrusion portion 34. Thus, it is possible to prevent variations in the winding shape and winding position of the first portion 11.

One of the first turn portions 13 may be in contact with the partition protrusion portion 36. Also, one of the first turn portions 13 may be in contact with the flange portion 39b. In this case, the first portion 11 can be formed in the first region 31 while fixing the first turn portion 13 (the first wire 10a) to the partition protrusion portion 36 and/or the flange portion 39b, and it is possible to prevent variations in the winding shape and winding position of the first portion 11.

Note that, one of the first turn portions 13 may be disposed separately from the first protrusion portion 34 located on its one side or both sides in the X-axis direction. That is, a gap (or gaps) may be formed between the first turn portion(s) 13 and the first protrusion portion(s) 34. Likewise, a gap may be formed between the first turn portion 13 and the partition protrusion portion 36 or the flange portion 39b.

The second coil 20 includes mutually continuous second turn portions 23. In the first layer of the second coil 20, the second turn portion 23 may be disposed on the first turn portion 13 and the first protrusion portion 34 while crossing over the first turn portion 13 and the first protrusion portion 34 next to each other. For more detail, the second turn portions 23 may be fixed in recesses (or gaps) between the first turn portions 13 and the first protrusion portions 34. In this case, the second turn portions 23 are less likely to be displaced, the positional relations between the first turn portions 13 and the second turn portions 23 are optimized, and the leakage magnetic flux between the first coil 10 and the second coil 20 can be adjusted to an appropriate value.

As described above, when the protrusion length of the first protrusion portions 34 is equal to the diameter of the first wire 10a, the steps between the first turn portions 13 and the first protrusion portions 34 can be reduced. Thus, when the second turn portions 23 are disposed on the first turn portions 13 and the first protrusion portions 34, the positional displacement of the second turn portions 23 can be prevented.

Note that, the second turn portions 23 do not necessarily have to be mounted on the first protrusion portions 34. For example, one of the second turn portions 23 may be mounted on one first turn portion 13 and the other first turn portion 13 next to each other while crossing over one first turn portion 13 and the other first turn portion 13. In this case, the second turn portion 23 can be fixed in a recess (or gap) between one first turn portion 13 and the other first turn portion 13, and the positional displacement of the second turn portions 23 can be prevented. Thus, the positional relations between the first turn portions 13 and the second turn portions 23 are optimized, and the leakage magnetic flux between the first coil 10 and the second coil 20 can be adjusted to an appropriate value.

In the first layer of the second coil 20, one second turn portion 23 and the other second turn portion 23 next to each other are in contact with each other, but may be separated from each other. Preferably, from the viewpoint of preventing positional displacement, the second turn portion 23 next to the partition protrusion portion 36 is in contact with the partition protrusion portion 36. The second turn portion 23 next to the flange portion 39b is disposed separately from the flange portion 39b, but may be in contact with the flange portion 39b from the viewpoint of preventing positional displacement.

The number of second turn portions 23 in the second layer of the second coil 20 is smaller than that in the first layer of the second coil 20. However, the number of second turn portions 23 in the second layer of the second coil 20 may be equal to or larger than the number of second turn portions 23 in the first layer of the second coil 20. In the second layer of the second coil 20, from the viewpoint of preventing positional displacement, one of the second turn portions 23 may be in contact with the partition protrusion portion 36. Also, from the viewpoint of preventing positional displacement, one of the second turn portions 23 may be in contact with the flange portion 39b.

In the second region 32, the second portion 12 of the first coil 10 consists of three layers along the radial direction. The second portion 12 is disposed between the partition protrusion portion 36 and the flange portion 39a. In the second region 32, from the viewpoint of preventing positional displacement, one of the first turn portions 13 may be in contact with the flange portion 39a. From the viewpoint of preventing positional displacement, one of the first turn portions 13 may be in contact with the partition protrusion portion 36. The partition protrusion portion 36 may protrude more outward than the outer peripheral surface of the second portion 12 along the radial direction of the tube portion 38.

As shown in FIG. 2, the first coil 10 includes lead portions 14a and 14b. The lead portion 14a is raised from the third layer of the second portion 12 (FIG. 6), for example, at a position next to the flange portion 39a and led out to the terminal block 40a. The lead portion 14b is raised from the first portion 11, for example, at a position next to the flange portion 39b (FIG. 5A). Then, the lead portion 14b is led out to the terminal block 40a while passing over the outer peripheral surfaces of the second coil 20 and the first coil 10 (second portion 12).

The second coil 20 includes lead portions 24a and 24b. The lead portion 24a is raised from the first layer of the second coil 20, for example, at a position next to the flange portion 39b and led out to the terminal block 40b. The lead portion 24b is raised from the second layer of the second coil 20 at any position of the coil 20 in its winding axis direction.

As shown in FIG. 1, the terminals 60a and 60b are attached to the terminal block 40a, and the terminals 60c and 60d are attached to the terminal block 40b. As shown in FIG. 2, each of the terminals 60a to 60d may include a fixation portion 61, a joint portion 62, and a wire connection portion 63.

The fixation portion 61 is a portion fixed to the terminal block 40a or 40b. The fixation portion 61 of the terminal 60a is attached to a terminal fixation portion 41m (FIG. 3) of the terminal block 40a. The fixation portion 61 of the terminal 60b is attached to the terminal fixation portion 41n (FIG. 3) of the terminal block 40a. The fixation portion 61 of the terminal 60c is attached to the terminal fixation portion 41m (FIG. 3) of the terminal block 40b. The fixation portion 61 of the terminal 60d is attached to the terminal fixation portion 41n (FIG. 3) of the terminal block 40b. Note that, a fastener (e.g., bolt) may be inserted into a through hole formed in the fixation portion 61. The terminal block 40a or 40b may be provided with a member (e.g., nut) for engaging with this fastener.

The wire connection portion 63 is a portion connected with the lead portion 14a, 14b, 24a, or 24b. The wire connection portion 63 has a ring shape and is configured to sandwich the lead portion 14a, 14b, 24a, or 24b. However, the shape of the wire connection portion 63 is not limited to this and may have, for example, a C shape. The lead portions 14a, 14b, 24a, or 24b may be laser-welded to the wire connection portion 63.

The joint portion 62 is a portion located between the fixation portion 61 and the wire connection portion 63 and connecting them. At least a part of the joint portion 62 of the terminal 60a may be disposed in the groove portion 42m (FIG. 3) of the terminal block 40a. At least a part of the joint portion 62 of the terminal 60b may be disposed in the groove portion 42n of the terminal block 40a. At least a part of the joint portion 62 of the terminal 60c may be disposed in the groove portion 42m of the terminal block 40b. At least a part of the joint portion 62 of the terminal 60d may be disposed in the groove portion 42n of the terminal block 40b.

Next, a method of manufacturing a coil device 1 is described. First, each member shown in FIG. 2 is prepared. Terminals 60a to 60d may be integrally formed with a bobbin 30. Instead, the terminals 60a to 60d may be retrofitted to the bobbin 30.

Next, as shown in FIG. 5A, a first coil 10 is formed around a tube portion 38 of the bobbin 30. For more detail, a first portion 11 of the first coil 10 is formed in a first region 31 of the tube portion 38 as follows. First, the first wire 10a is wound around a section between a flange portion 39b and a first protrusion portion 34 next to the flange portion 39b. Next, the first wire 10a is transferred to the next section via a notch 37 (FIG. 3) of the first protrusion portion 34 and wound between one first protrusion portion 34 and an other first protrusion portion 34. This is sequentially repeated, and the first wire 10a is finally wound in a section between the partition protrusion portion 36 and the first protrusion portion 34 next to the partition protrusion portion 36. Accordingly, the first portion 11 (first turn portions 13) is formed in the first region 31.

Next, a second portion 12 of the first coil 10 is formed in a second region 32 of the tube portion 38 as follows. First, the first wire 10a is transferred from the first region 31 to the second region 32 via a notch 37 (FIG. 3) of the partition protrusion portion 36. Then, the first wire 10a is wound around the outer peripheral surface of the tube portion 38 from the partition protrusion portion 36 toward the flange portion 39a to form a first layer of the second portion 12. Next, the first wire 10a is wound around the outside of the first layer from the flange portion 39a toward the partition protrusion portion 36 to form a second layer of the second portion 12. Next, the first wire 10a is wound around the outside of the second layer from the partition protrusion portion 36 toward the flange portion 39a to form a third layer of the second portion 12. Accordingly, the second portion 12 is formed in the second region 32.

Next, as shown in FIG. 5A and FIG. 6, a second coil 20 is formed around the outside of the first coil 10 as follows. First, the winding of the second wire 20a around the outside of the first portion 11 is started from a position next to the flange portion 39b. Then, the second wire 20a is wound to a position next to the partition protrusion portion 36 to form a first layer of the second wire 20a. Next, the second wire 20a is wound around the outside of the first layer from the partition protrusion portion 36 toward the flange portion 39b to form a second layer of the second wire 20a. Accordingly, the second coil 20 is formed.

Next, as shown in FIG. 1, a lead portion 14a of the first coil 10 is connected to a wire connection portion 63 (FIG. 2) of the terminal 60a. Also, a lead portion 14b of the first coil 10 is connected to a wire connection portion 63 (FIG. 2) of the terminal 60b. Also, a lead portion 24a of the second coil 20 is connected to a wire connection portion 63 (FIG. 2) of the terminal 60c. Also, a lead portion 24b of the second coil 20 is connected to a wire connection portion 63 (FIG. 2) of the terminal 60d. If necessary, the lead portions 14a, 14b, 24a, and 24b may be laser-welded.

Next, cores 50a to 50d are attached to the bobbin 30. For more detail, a middle leg portion 53 (FIG. 2) of each of the cores 50a to 50d is engaged with a through hole 38a (FIG. 3) of the tube portion 38. If necessary, the cores 50a to 50d may be adhered to each other. Accordingly, the coil device 1 can be manufactured.

In the present embodiment, as shown in FIG. 6, when the second coil 20 is provided outside the first portion 11 of the first coil 10, the effect of reducing leakage magnetic flux between the first coil 10 and the second coil 20 is exhibited. Moreover, when the second coil 20 is next to the second portion 12 of the first coil 10 along the X-axis, the effect of increasing leakage magnetic flux is exhibited. Thus, the coil device 1 has a portion for contributing to reduction in leakage magnetic flux and a portion for contributing to increase in leakage magnetic flux. Then, by organically combining these portions, the leakage magnetic flux can be adjusted to an appropriate value without enlargement or complication of the coil device 1.

In particular, when the layer number of the first portion 11 in its radial direction is one, the winding number of the first portion 11 can be reduced, and it is thus possible to prevent variations in the winding shape and winding position of the first portion 11. As a result, it is also possible to prevent variations in winding shape and winding position for the second coil 20 disposed on the first portion 11. This makes it possible to prevent variations in the leakage magnetic flux and to adjust the leakage magnetic flux to an appropriate value.

Also, as shown in FIG. 3, the notches 37 are formed in the first protrusion portions 34. Thus, as shown in FIG. 5, when the first portion 11 is formed in the first region 31, the first wire 10a can be wound from one side to the other side via the notches 37 along the X-axis without being hindered by the first protrusion portions 34.

Also, as shown in FIG. 3, the notch 37 is formed in the partition protrusion portion 36. Thus, as shown in FIG. 5A, the first wire 10a can continuously be wound around the tube portion 38 via the notch 37 from the first portion 11 to the first layer of the second portion 12.

### Second Embodiment

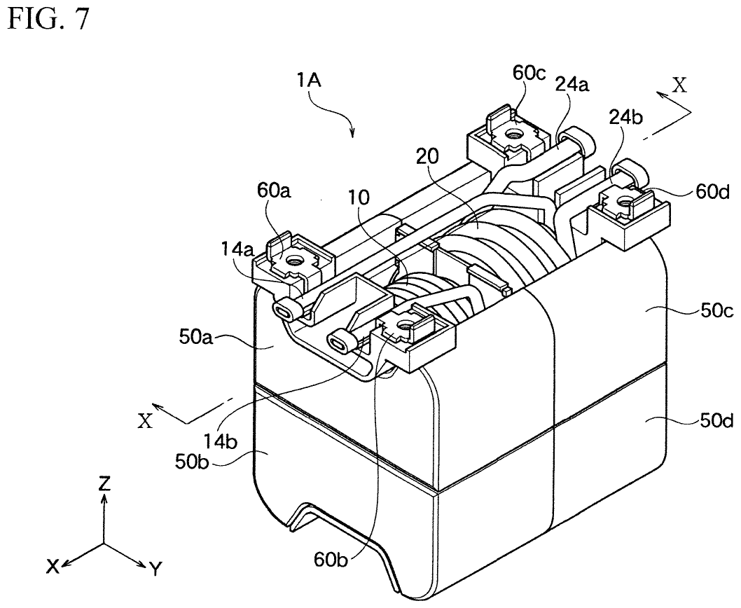

Except for the following matters, a coil device 1A of Second Embodiment shown in FIG. 7 has the same configurations as the coil device 1 of First Embodiment. Overlapping members with the coil device 1 of First Embodiment are provided with the same reference numerals and are not described in detail.

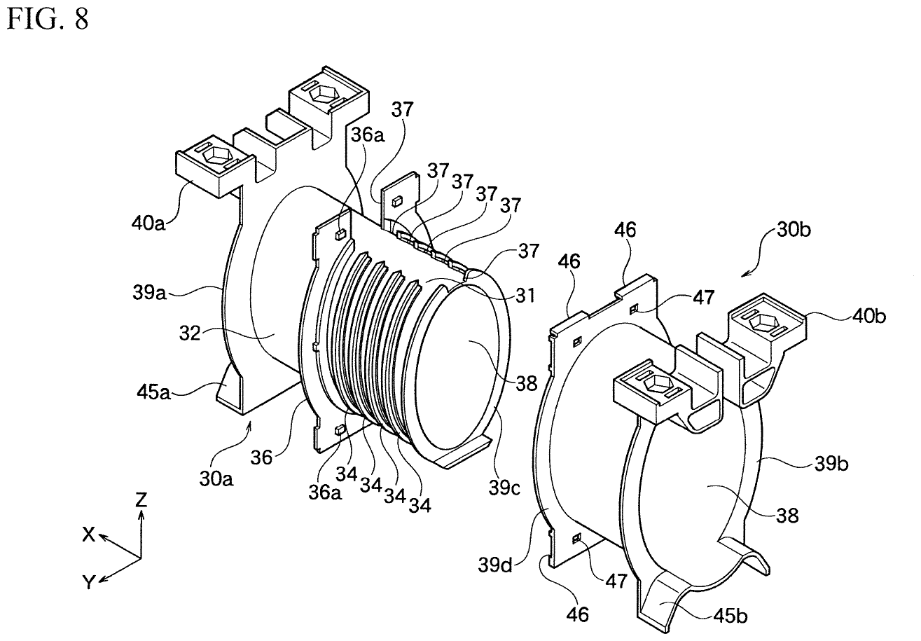

As shown in FIG. 8, the coil device 1A includes a bobbin 30a and a bobbin 30b combined with the bobbin 30a. The bobbin 30a includes the tube portion 38 and the terminal block 40a. The configuration of the terminal block 40a is described in First Embodiment and is not described in the present embodiment. The first protrusion portions 34, the partition protrusion portion 36, the flange portion 39a, and a flange portion 39c are formed on the outer peripheral surface of the tube portion 38. The configuration of the flange portion 39a is described in First Embodiment and is not described in the present embodiment. The first protrusion portions 34 may be formed in a stepped shape.

At least one engagement protrusion portion 36a may be formed at the upper end and/or the lower end of the partition protrusion portion 36. The engagement protrusion portion 36a protrudes toward the bobbin 30b. A plurality (e.g., two) of engagement protrusion portions 36a may be formed at the upper end of the partition protrusion portion 36, and a plurality of (e.g., two) engagement protrusion portions 36a may be formed at the lower end of the partition protrusion portion 36. The flange portion 39c is formed at an end of the tube portion 38 in the X-axis direction and is located on the opposite side of the flange portion 39a. The flange portion 39c protrudes in the radial direction from the outer circumferential surface of the tube portion 38. The notch 37 may be formed in a part of the flange portion 39c in its circumferential direction.

The bobbin 30b includes a tube portion 38 and a terminal block 40b. The configuration of the terminal block 40b is described in First Embodiment and is not described in the present embodiment. The flange portion 39b and a flange portion 39d are formed on the outer circumferential surface of the tube portion 38. The configuration of the flange portion 39b is described in First Embodiment and is not described in the present embodiment. The flange portion 39d is formed at an end of the tube portion 38 in the X-axis direction and is located on the opposite side of the flange portion 39b. The flange portion 39d protrudes in the radial direction from the outer circumferential surface of the tube portion 38. A plurality (e.g., two) of engagement portions 46 may be formed at the upper end of the flange portion 39d. Also, a plurality (e.g., two) of engagement portions 46 may be formed at the lower end of the flange portion 39d. The engagement portions 46 protrude toward the bobbin 30a.

At least one engagement recess portion 47 may be formed at the upper end and the lower end of the flange portion 39d. A plurality (e.g., two) of engagement recess portions 47 may be formed at the upper end of the flange portion 39d, and a plurality (e.g., two) of engagement recess portions 47 may be formed at the lower end of the flange portion 39d. Note that, unlike the bobbin 30a, the first protrusion portions 34 are not formed on the outer circumferential surface of the tube portion 38 of the bobbin 30b.

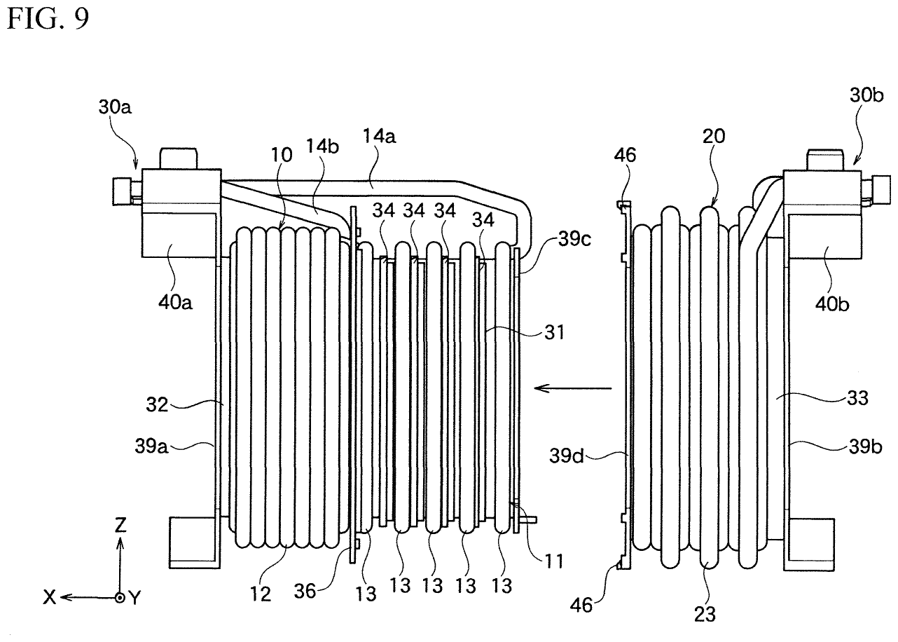

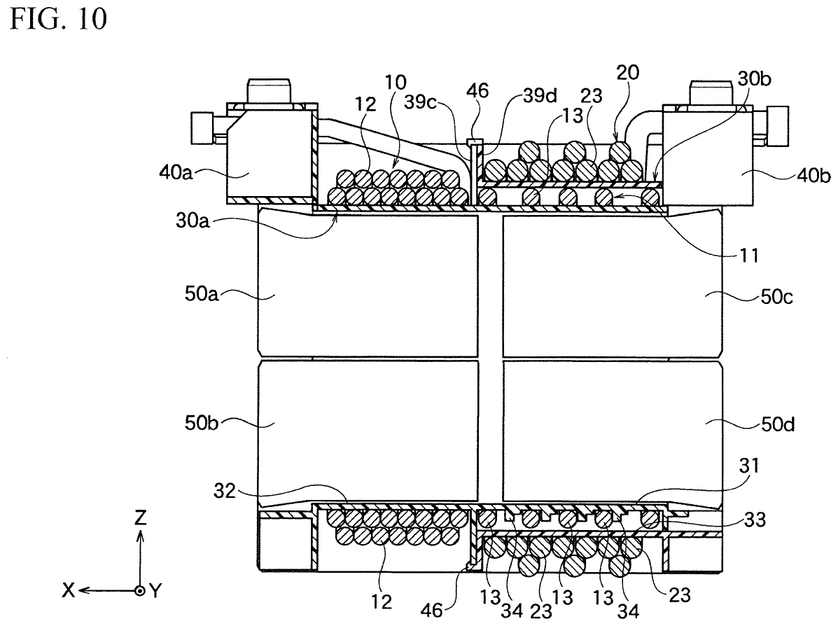

As shown in FIG. 9, the bobbin 30a includes the first region 31 and the second region 32. The first portion 11 of the first coil 10 is disposed in the first region 31, and the second portion 12 of the first coil 10 is disposed in the second region 32. The layer number of the second portion 12 in its radial direction may be two (FIG. 10). At a position next to the flange portion 39c, the lead portion 14a may be led out from the first region 31 toward the terminal block 40a and connected to the terminal 60a (FIG. 7). At a position next to the partition protrusion portion 36, the lead portion 14b may be led out from the second region 32 toward the terminal block 40a and connected to the terminal 60b (FIG. 7).

The bobbin 30b includes a third region 33. The second coil 20 is disposed (wound) in the third region 33. The layer number of the second coil 20 in its radial direction may be two (FIG. 10). At a position next to the flange portion 39b, the lead portion 24a may be led out from the third region 33 toward the terminal block 40b and connected to the terminal 60c (FIG. 7). At a position next to the flange portion 39b, the lead portion 24b may be led out from the third region 33 toward the terminal block 40b and connected to the terminal 60d (FIG. 7).

As shown in FIG. 10, when the bobbin 30a and the bobbin 30b are combined, the engagement portions 46 at the upper end of the flange portion 39d of the bobbin 30b are engaged with the upper end of the flange portion 39c of the bobbin 30a. Also, the engagement portions 46 at the lower end of the flange portion 39d are engaged with the lower end of the flange portion 39c. This makes it possible to prevent the bobbin 30b from coming off the bobbin 30a.

In the state where the bobbin 30b is combined with the bobbin 30a, the third region 33 is disposed outside the first region 31 in its radial direction. Then, the first portion 11 of the first coil 10 is disposed in the first region 31, and the second coil 20 is disposed in the third region 33. Thus, the second coil 20 is disposed outside the first portion 11 of the first coil 10 in its radial direction, and the first portion 11 and the second coil 20 are arranged along the radial direction.

Also in the present embodiment, the same effects as in First Embodiment are obtained. Moreover, in the present embodiment, since the second coil 20 is disposed outside the first portion 11 in its radial direction, the effect of reducing leakage magnetic flux is exhibited. Also, the radial distance between the first coil 10 (first portion 11) and the second coil 20 can be adjusted depending on the diameter of the bobbin 30b. This makes it possible to adjust the leakage magnetic flux between the first coil 10 and the second coil 20 to an appropriate value.

### Third Embodiment

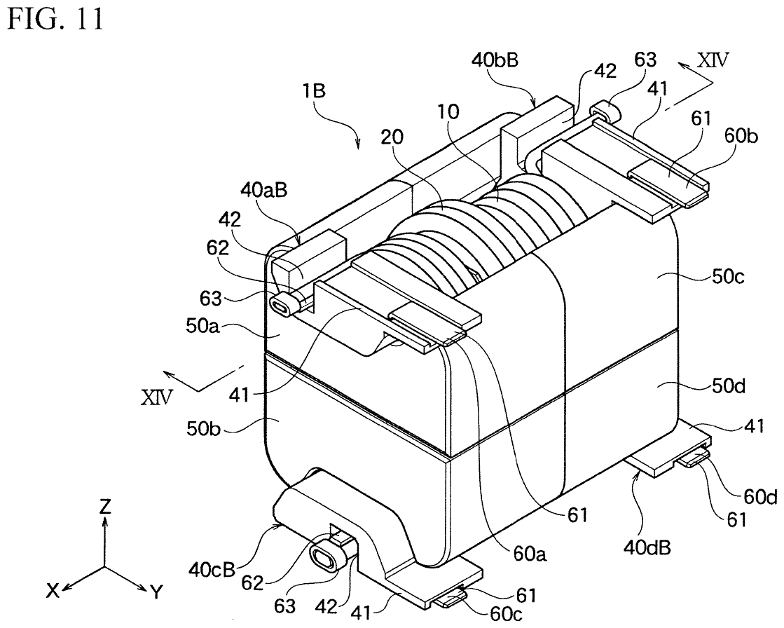

Except for the following matters, a coil device 1B of Third Embodiment shown in FIG. 11 has the same configurations as the coil device 1 of First Embodiment. Overlapping members with the coil device 1 of First Embodiment are provided with the same reference numerals and are not described in detail.

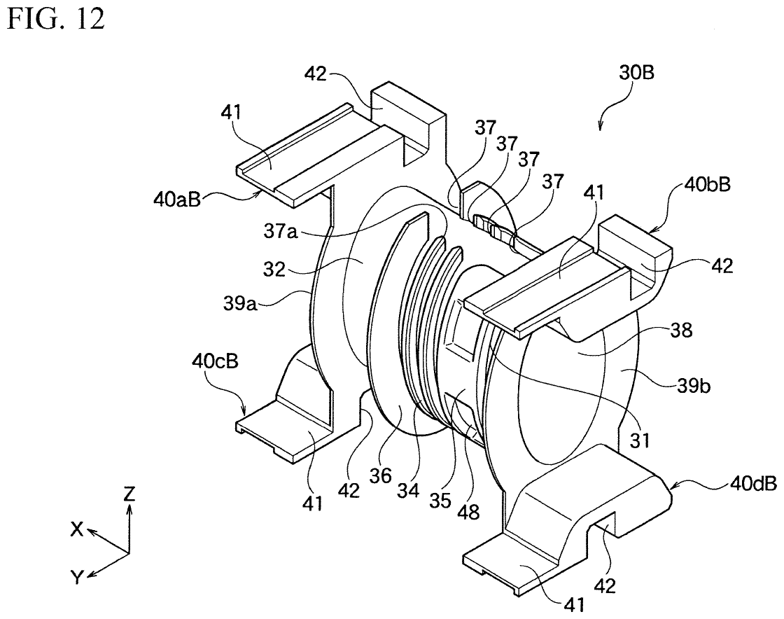

As shown in FIG. 12, the coil device 1B includes a bobbin 30B. The bobbin 30B is different from the bobbin 30 of First Embodiment in that the bobbin 30B includes a second protrusion portion 35 and terminal blocks 40aB to 40dB. The second protrusion portion 35 is formed on the outer peripheral surface of the tube portion 38 of the bobbin 30B and protrudes in the radial direction of the tube portion 38. The first protrusion portions 34 and the second protrusion portion 35 are arranged along the axial direction of the tube portion 38. The width of the second protrusion portion 35 in the X-axis direction is different from the width of the first protrusion portions 34 in the X-axis direction. The width of the second protrusion portion 35 in the X-axis direction may be twice or more or five times or more the width of the first protrusion portions 34 in the X-axis direction.

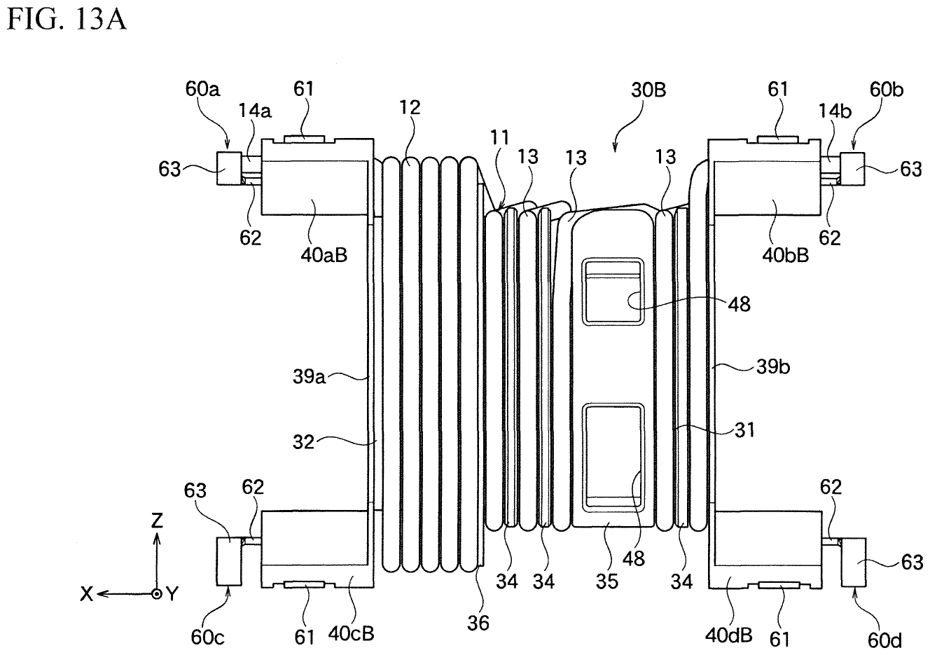

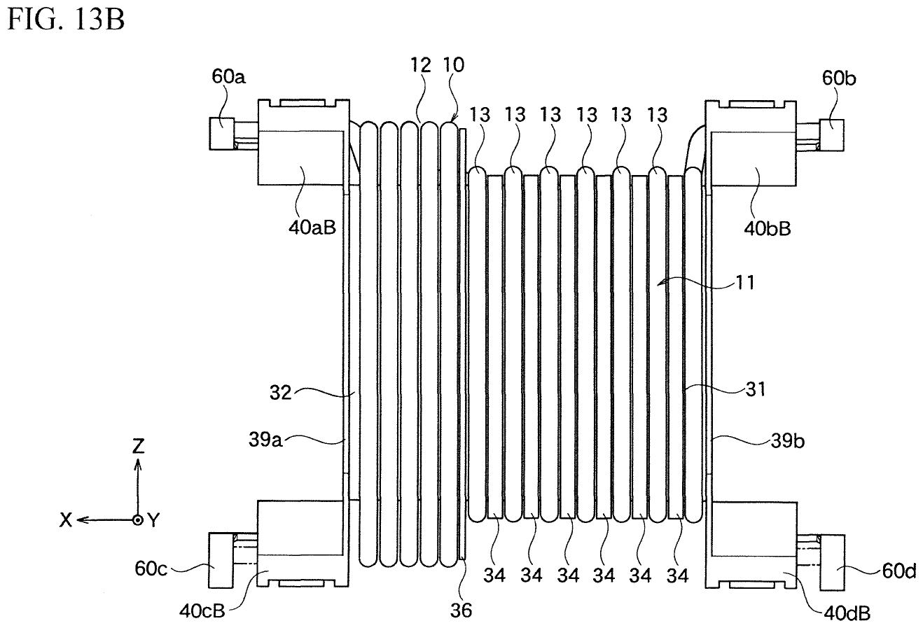

The second protrusion portion 35 may be provided with one or more recess portions 48. The recess portion 48 is mainly formed for the purpose of reduction in the weight of the bobbin 30 or in consideration of ease of removal from a mold. As shown in FIG. 13A, the second protrusion portion 35 may be located between one first protrusion portion 34 and the other first protrusion portion 34. Instead, the first protrusion portions 34 may be collectively formed on one side of the bobbin 30B in its axial direction, and the second protrusion portion 35 may be formed on the other side of the bobbin 30B in its axial direction. Note that, the number of second protrusion portions 35 may be plural.

The protrusion length of the second protrusion portion 35 is equal to the protrusion length of the first protrusion portions 34, but may be smaller or larger than the protrusion length of the first protrusion portions 34. As shown in FIG. 12, the notch 37 may be formed in a part of the second protrusion portion 35 in its extending direction (circumferential direction). This is for passing the first wire 10a from one side to the other side in the X-axis direction through the second protrusion portion 35.

The terminal block 40aB is formed at the upper end of the flange portion 39a, and the terminal block 40cB is formed at the lower end of the flange portion 39a. The terminal blocks 40aB and 40cB protrude from an end surface of the flange portion 39a toward one side in the X-axis direction. The terminal block 40aB may include a terminal fixation portion 41 and a recess portion 42. Likewise, the terminal block 40cB may include a terminal fixation portion 41 and a recess 42. However, the configurations of the terminal blocks 40aB and 40cB are not limited to the configurations shown in FIG. 12.

The terminal block 40bB is formed at the upper end of the flange portion 39b, and the terminal block 40dB is formed at the lower end of the flange portion 39b. The terminal blocks 40bB and 40dB protrude from an end surface of the flange portion 39b toward the other side in the X-axis direction. The terminal block 40bB may include a terminal fixation portion 41 and a recess portion 42. Likewise, the terminal block 40dB may include a terminal fixation portion 41 and a recess 42. However, the configurations of the terminal blocks 40bB and 40dB are not limited to the configurations shown in FIG. 12.

As shown in FIG. 11, in the terminal block 40aB, the fixation portion 61 of the terminal 60a may be fixed to the terminal fixation portion 41, and the joint portion 62 and/or the wire connection portion 63 of the terminal 60a may be arranged (accommodated) in the groove portion 42. In the terminal block 40cB, the fixation portion 61 of the terminal 60c may be fixed to the terminal fixation portion 41, and the joint portion 62 and/or the wire connection portion 63 of the terminal 60c may be arranged (accommodated) in the groove portion 42.

In the terminal block 40bB, the fixation portion 61 of the terminal 60b may be fixed to the terminal fixation portion 41, and the joint portion 62 and/or the wire connection portion 63 of the terminal 60b may be arranged (accommodated) in the groove portion 42. In the terminal block 40dB, the fixation portion 61 of the terminal 60d may be fixed to the terminal fixation portion 41, and the joint portion 62 and/or the wire connection portion 63 of the terminal 60d may be arranged (accommodated) in the groove portion 42.

As shown in FIG. 13A, the first portion 11 of the first coil 10 is formed in the first region 31 of the tube portion 38, and the second portion 12 is formed in the second region 32. The lead portion 14a of the first coil 10 is connected to the wire connection portion 63 of the terminal 60a. The lead portion 14b of the first coil 10 is connected to the wire connection portion 63 of the terminal 60b.

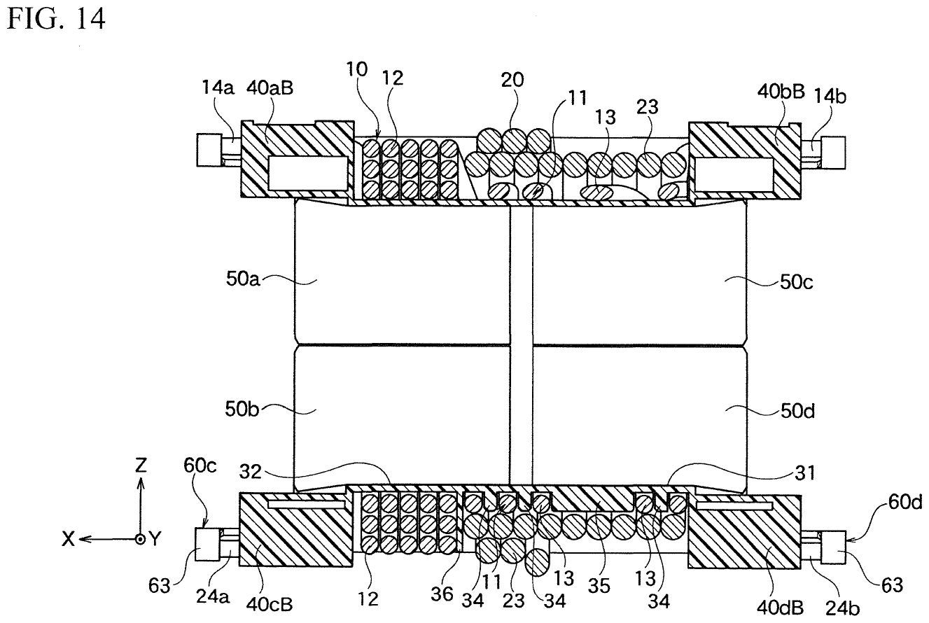

As shown in FIG. 14, the second coil 20 is formed in two layers in the radial direction on the outer peripheral surface of the first portion 11. The second layer of the second coil 20 may be unevenly distributed on one side of the first region 31 in its axial direction (on the partition protrusion portion 36 side). The lead portion 24a of the second coil 20 is connected to the wire connection portion 63 of the terminal 60c. The lead portion 24b of the second coil 20 is connected to the wire connection portion 63 of the terminal 60d.

Also in the present embodiment, the same effects as in First Embodiment are obtained. Moreover, in the present embodiment, as shown in FIG. 14, the distance in the X-axis direction between one first turn portion 13 and an other first turn portion 13 next to each other can be adjusted at the position of the second protrusion portion 35. In the present embodiment, the width of the second protrusion portion 35 in the X-axis direction is larger than the width of the first protrusion portions 34 in the X-axis direction. Thus, the distance between one first turn portion 13 and the other first turn portion 13 in the X-axis direction can be increased at the position of the second protrusion portion 35. This makes it possible to adjust the winding shape and the winding position of the first coil 10 and to adjust the leakage magnetic flux between the first coil 10 and the second coil 20 to an appropriate value.

Note that, the present invention is not limited to the above-described embodiments and may variously be modified within the scope of the present invention. For example, in the above-described embodiments, application examples of the present disclosure to a leakage transformer are described, but the present disclosure is also applicable to transformers other than leakage transformers.

In each of the above-described embodiments, as shown in FIG. 5B, each of the first protrusion portions 34 may include at least one wide portion 34a and at least one narrow portion 34b. The width of the wide portion 34a in the X-axis direction is larger than the width of the narrow portion 34b in the X-axis direction. The width of the wide portion 34a in the X-axis direction is similar to the width of the wide portion 34 (FIG. 5A) in the X-axis direction according to First Embodiment. The width of the narrow portion 34b in the X-axis direction is not limited and may be ½ or less or ⅓ or less of the width of the wide portion 34a in the X-axis direction. The winding shape and winding position of the first coil 10 can be adjusted (e.g., the first turn portions 13 are moved to the positive side of the first region 31 in the X-axis direction) at the position of the wide portion 34a by winding the first wire 10a around the first region 31 so that the first wire 10a passes next to the wide portion 34. This makes it possible to adjust the leakage magnetic flux between the first coil 10 and the second coil 20 to an appropriate value.

In Third Embodiment mentioned above, as shown in FIG. 13B, the second protrusion portion 35 may be omitted from the first region 31, and only the first protrusion portions 34 may be formed in the first region 31.

In First Embodiment mentioned above, the bobbin 30 may be omitted from the coil device 1. In this case, the cores 50a to 50d (e.g., the middle leg portions 53 of the cores 50a to 50d) may be provided with the first coil 10.

In each of the above-described embodiments, the first coil 10 and the second coil 20 may be air-core coils.

### DESCRIPTION OF THE REFERENCE NUMERICAL

1, 1A, 1B . . . coil device
10 . . . first coil
10a . . . first wire
11 . . . first portion
12 . . . second portion
13 . . . first turn portion
14a, 14b . . . lead portion
20 . . . second coil
20a . . . second wire
23 . . . second turn portion
24a, 24b . . . lead portion
30, 30a, 30b, 30B . . . bobbin
31 . . . first region
32 . . . second region
33 . . . third region
34 . . . first protrusion portion
34a . . . wide portion
34b . . . narrow portion
35 . . . second protrusion portion
36 . . . partition protrusion portion
36a . . . engagement protrusion portion
37 . . . notch
37a . . . tip portion
38 . . . tube portion
38a . . . through hole
39a-39d . . . flange portion
40a-40d, 40aB-40dB . . . terminal block
41, 41m, 41n . . . terminal fixation portion
42, 42m, 42n . . . groove portion
43 . . . insulating portion
44a, 44b . . . projection
45a, 45b . . . leg portion
46 . . . engagement portion
47 . . . engagement recess portion
48 . . . recess portion
50a-50d . . . core
51 . . . base portion
52 . . . outer leg portion
53 . . . middle leg portion
54 . . . base recess portion
55 . . . outer leg recess portion
60a-60d . . . terminal
61 . . . fixation portion
62 . . . joint portion
63 . . . wire connection portion

What is claimed is:

1. A coil device comprising:
a first coil formed by a first wire wound in a coil shape; and
a second coil formed by a second wire wound in a coil shape,
wherein
the first coil includes:
a first portion provided inside the second coil; and
a second portion next to the first portion and the second coil along a winding axis of the first portion,
a layer number of the first portion in its radial direction is one, and
a layer number of the second portion in its radial direction is plural.

2. The coil device according to claim 1, wherein
the first portion includes mutually continuous first turn portions, and
the first turn portions next to each other are separated from each other along the winding axis.

3. The coil device according to claim 2, wherein
the second portion includes mutually continuous second turn portions, and
one of the second turn portions is disposed on the first turn portions next to each other while crossing over the first turn portions.

4. The coil device according to claim 1, wherein the first portion and a first layer of the second portion are continuous to each other.

5. The coil device according to claim 1, further comprising a bobbin for disposing the first coil, wherein
the bobbin includes a first region for disposing the first portion, and
protrusion portions protruding in a radial direction of the bobbin are arranged along an axial direction of the bobbin on an outer peripheral surface of the first region.

6. The coil device according to claim 5, wherein
the protrusion portions extend along a circumferential direction of the bobbin,
one of the protrusion portions is provided with a notch, and
the first wire passes through the notch.

7. The coil device according to claim 5, wherein
the first portion includes mutually continuous first turn portions, and
one of the first turn portions is disposed between the protrusion portions next to each other.

8. The coil device according to claim 5, wherein
the first portion includes mutually continuous first turn portions,
the second coil includes mutually continuous second turn portions,
one of the first turn portions is next to one of the protrusion portions along the winding axis, and
one of the second turn portions is disposed on one of the first turn portions and one of the protrusion portions next to each other while crossing over the one of the first turn portions and the one of the protrusion portions.

9. The coil device according to claim 5, wherein a protrusion length of the protrusion portions is equal to a diameter of the first wire.

10. The coil device according to claim 5, wherein
one of the protrusion portions includes a wide portion and a narrow portion, and
a width of the wide portion is larger than a width of the narrow portion in the axial direction of the bobbin.

11. The coil device according to claim 5, wherein
the protrusion portions include:
a first protrusion portion; and
a second protrusion portion having a width along the axial direction of the bobbin different from that of the first protrusion, and
the first protrusion portion and the second protrusion portion are arranged along the axial direction of the bobbin.

12. The coil device according to claim 5, wherein
the bobbin includes:
a second region for disposing the second portion; and
a partition protrusion portion protruding in the radial direction of the bobbin,
the partition protrusion portion is formed on the outer peripheral surface of the bobbin between the first region and the second region and provided with a notch, and
the first wire passes through the notch.

13. The coil device according to claim 5, wherein
the bobbin includes:
a first bobbin for disposing the first coil; and
a second bobbin for disposing the second coil,
the first bobbin includes the first region,
the second bobbin includes a third region for disposing the second coil, and
the third region is provided outside the first region.

14. A coil device comprising:
a bobbin;
a first coil provided to the bobbin;
a second coil provided outside the first coil,
wherein
the first coil includes:
a first portion provided inside the second coil; and
a second portion next to the first portion and the second coil along a winding axis of the first portion,
the bobbin includes a first region for disposing the first portion, and
protrusion portions protruding in a radial direction of the bobbin are arranged on an outer peripheral surface of the first region along an axial direction of the bobbin.
